(19) United States
(12) Patent Application Publication
(10) Pub. No.: US 2014/0098523 A1
(43) Pub. Date: Apr. 10, 2014

(54) LIGHTED SAFETY BELT

(71) Applicant: JOHN A. SUTTON, Jacksonville, FL (US)

(72) Inventor: JOHN A. SUTTON, Jacksonville, FL (US)

(21) Appl. No.: 13/646,137

(22) Filed: Oct. 5, 2012

(51) Int. Cl. F21V 21/08; F21V 31/00; F21V 5/04

(52) U.S. Cl. 362/103

(57) ABSTRACT

A lighted safety belt to provide path lighting for the wearer and to signal presence of the wearer on approaching traffic. The safety belt comprises a band of flexible nylon material having a front segment and a rear segment, a series of light emitting diodes in the front segment to provide path lighting in a direction of movement of the wearer, a light diffusing strip coextensive with a portion of the rear segment of the band to scatter light emitted from a series of light-emitting diodes associated therewith, a battery, a wiring harness to provide electrical power to path-lighting diodes and the diffusing strip, and a controller to control on-off switching of power to or blinking pattern for the path-lighting diodes and the diffusing strip.

### BACKGROUND

This invention relates to a safety belt worn by an individual to provide path lighting in darkness and also to signal the wearer's presence to approaching traffic.

Safety belts have been used to reduce risks of injury during a variety of activities, such as bicycling, jogging, traffic directing, construction, road working, or any other activity where increased visibility is desired. Children and pets often use such belts for added visibility.

The present invention aims to further improve the aim of safety belts by providing self-contained source of light, for both path lighting of forward direction of travel and to signal a person's presence to traffic approaching from the rear or front.

### SUMMARY OF THE INVENTION

According to the invention, there is provided a lighted safety belt to provide path lighting for the wearer and to signal presence of the wearer on approaching traffic. The safety belt comprises a band of flexible material having a front segment and a rear segment, a series of light emitting diodes in the front segment to provide path lighting in a direction of movement of the wearer, a light diffusing strip coextensive with a portion of the rear segment of the band to scatter light emitted from a series of light-emitting diodes associated therewith, a battery, a wiring harness to provide electrical power to path-lighting diodes and the diffusing strip, and a controller to control on-off switching of power to or blinking pattern for the path-lighting diodes and the diffusing strip.

Further aspects of the invention include the controller providing pre-defined blinking patterns for the diffusing strip LEDs; the path lighting diodes including lenses to focus emitted light in a forward direction of movement of the wearer; a wiring harness comprising intrinsically conductive flexible polymers as conductors; the controller being encapsulated with a moisture-impermeable layer of material to provide moisture-proofing or water-proofing; the controller providing selectable blinking patterns for either of both the path lighting diodes and the light diffusing strip; the diffusing strip comprising respective banks of different color diodes wherein the controller controls on-off switching or blinking patterns for each respective group of different color diodes; and a compartment in the waist band or shoulder strap to house the controller and battery.

Other features of the invention will become apparent upon review of the following description taken in connection with the accompanying drawings. The invention, though, is pointed out with particularity by the appended claims.

### BRIEF DESCRIPTION OF THE DRAWINGS

FIGS. 1A and 1B respectively illustrate an illuminated safety belt, in accordance with the present invention, that encircles an individual's waist where path-lighting LEDs are positioned in front of the belt and an LED-illuminated red diffuser strip is positioned on a rear of the belt.

FIGS. 2A and 2B respectively illustrate an shoulder harness type safety belt including a waist band to encircles an individual's waist and a shoulder strap that lies across the chest and back of an individual, where path-lighting LEDs are positioned on the shoulder strap in front of the wearer and an LED-illuminated red diffuser strip is positioned on the shoulder strap on a rear of the wearer, in accordance with the present invention.

FIG. 3 illustrates an exemplary controller, battery source, and wiring harness that may be positioned in a compartment of the safety belts of FIGS. 1A, 1B, 2A and 2B, e.g., in a housing of a buckle thereof, in accordance with the present invention.

### DESCRIPTION OF ILLUSTRATIVE EMBODIMENTS

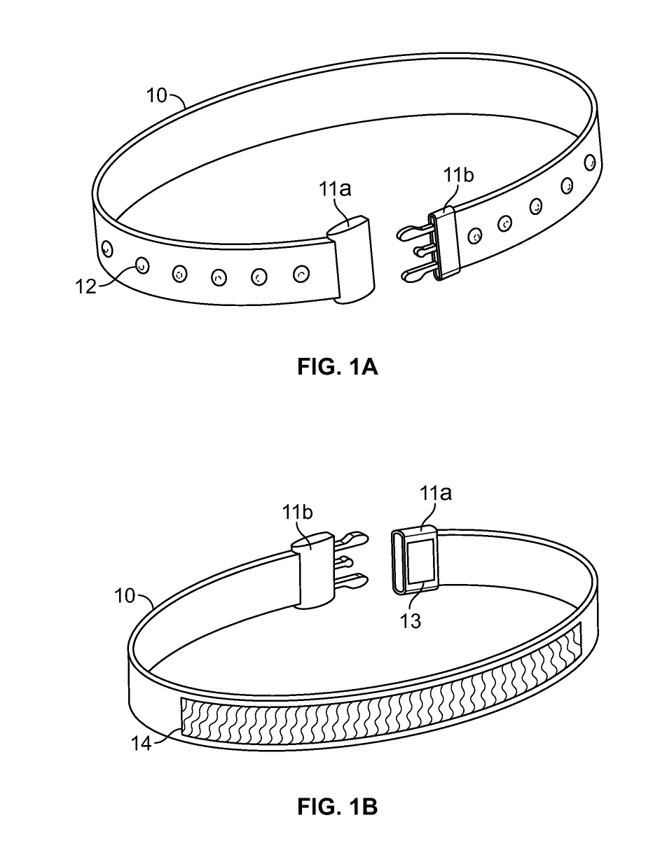

Referring to FIGS. 1A and 1B, exemplary belt 10 includes a clamping or buckle mechanism 11a and 11b, front and rear portions to encircle the waist of a wearer, and a series of LEDs (light-emitting diodes) to provide path lighting and signaling of the wearer's presence in darkness. Nylon, plastic, woven fabric or other light-weight flexible material may be used for the material of belt 10. The size, thickness and length of belt 10 may vary according to a requirement or the nature of use. In one embodiment, the invention comprises a series of bright, forward-facing, low-power LEDs 12 (only one labeled in the drawing) on the front of belt 10 to illuminate a wide path of the wearer's direction of travel, e.g., up to twenty-five feet or more in distance. LEDs, for example, may provide up to 100,000 hours of life, and two or more circular, flat CR2032 three-volt lithium or similar batteries may provide forty to seventy hours of LED activation time for a number of LEDs. Path-lighting LEDs in the front of belt 10 may include integral lens to focus directional lighting in the direction of the wearer's movement.

On the rear of belt 10, a panel in the form of a red diffuser strip 14 is capable of signaling the presence of the wearer up to one thousand feet away when activated by LEDs. This drastically increases visibility to motorists approaching from the rear. Diffuser strip 14 includes a series of LEDs over which a light diffusing or light scattering strip of material is placed, as known in the art. Red, yellow, or orange colors may be preferred to alert approaching traffic. Different colors may be achieved by the color of the diffuser material using white-light emitting diodes, or even by the native color of LED emissions, such as red or a combination of LED emissions to obtain a yellow or orange color. Red-emitting LEDs are readily available. LEDs underneath or embedded within the light-diffusing material of strip 14 may have an arrangement similar to LED arrangement of the front portion of belt 10. Fewer diodes may be employed for the diffuser strip 14 according to the desired luminosity needed for distance signaling. Also, diffuser strip 14 may be augmented with reflective material to provide added visibility from headlamps of approaching vehicles. Alternatively, diffuser strip 14 may be replaced by a series of closely spaced red-emitting and/or other LEDs to establish a solid strip when viewed from a distance.

A lighting control circuit and power source, e.g., a battery, may but need not reside in a housing 13 of the buckle mechanism 11 or other compartment formed in or with belt 10. A flexible wiring harness (not shown) runs coextensively along and within the material of belt 10 to supply power from the battery of housing 13 to the LEDs. The wiring harness comprises respective bundles of conductors separately for the path-lighting and diffuser strip LEDs. Control may include on-off switching and blinking pattern control for each of the path-lighting and diffuser strip LEDs.

In addition, a plurality of belts 10 may be daisy-chained together to provide a longer lighting source. This may be desired for added lighting, e.g., for such uses as camping, tailgating, boating, and other uses.

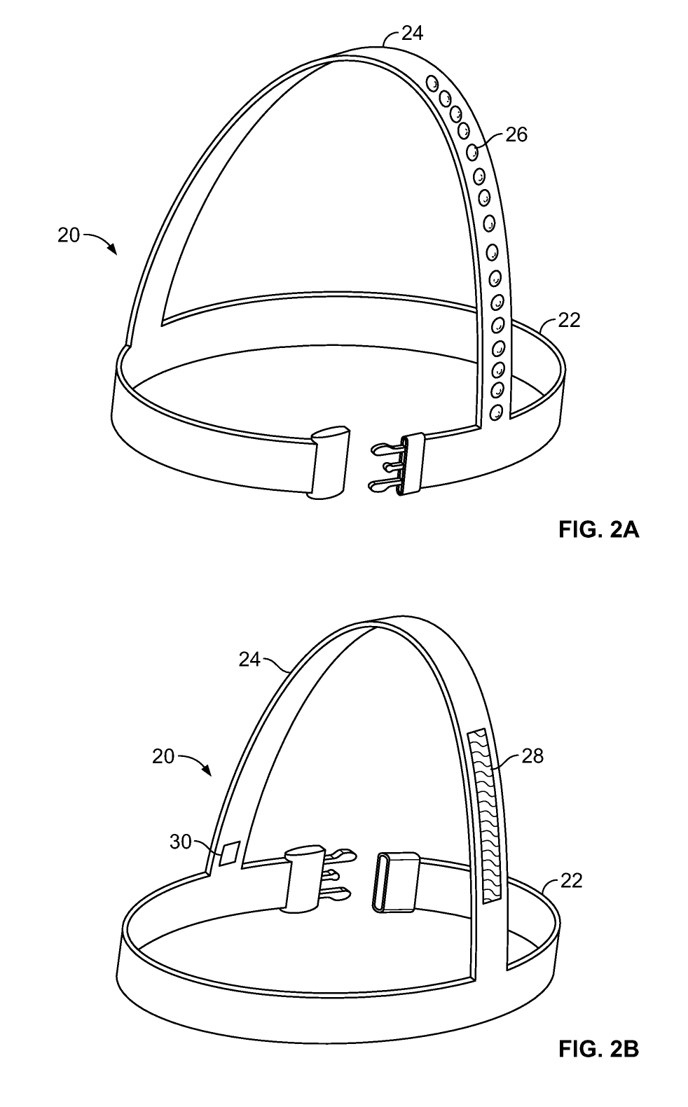

FIGS. 2A and 2B show an alternative embodiment of the invention in which the illuminated safety belt 20 comprises both a waist band 22 and shoulder strap 24. In this embodiment, shoulder strap 24 includes path-lighting diodes 26 (only one denoted in the drawing) in the front of belt 20, and a red (or other color) diffuser strip 28 on the rear of the shoulder strap. Instead of a diffuser strip 28, the rear of the shoulder strap may simply comprise a series of red (or other color) emitting LEDs. Moreover, the waist band 22 may additionally include lighting similar to the lighting arrangement of FIGS. 1A and 1B so that both the shoulder strap and waist band are illuminated. A housing 30 embedded in the shoulder strap 24 (FIG. 1B) may house a battery and LED controller. The battery and controller, however, may be disposed elsewhere in the belt 20, or even in a detachable appendage electrically connected to the belt.

Different belt configurations may be arranged for pets (e.g., dogs and cats) according to their corporal structure. The safety belts described herein only illustrate their use on human subjects, but is not limited thereto. The safety belt may also include an attachment for a bottle holder or other implement, which may be desired by campers, runners and joggers.

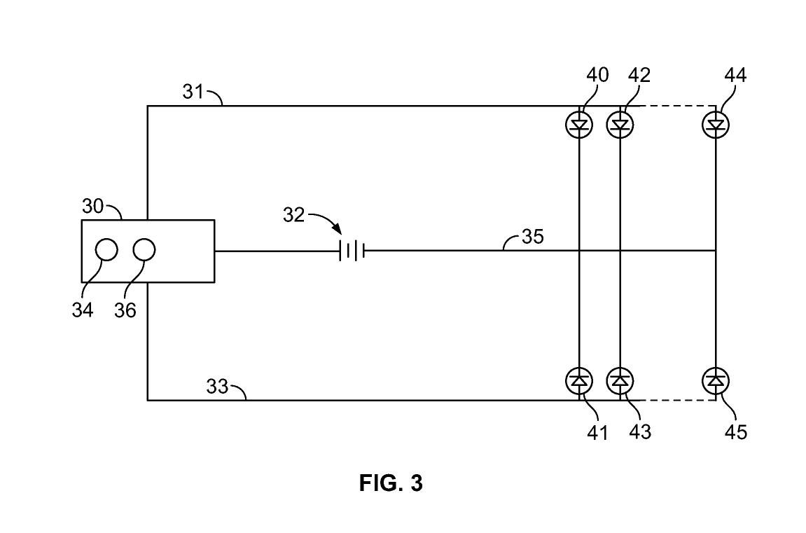

FIG. 3 illustrates an exemplary controller 30 and battery 32 that may be housed in housing 13 of FIG. 1B or housing 30 of FIG. 2B. The wiring harness includes conductors 31 and 33 to couple a positive voltage to anodes of the LEDs and a conductor 35 to supply a negative voltage to cathodes of the LEDs. Conductor 31 enables switched power feeds to any number of path-lighting diodes 40, 42, 44 in the front of belt 10 (FIG. 1B) or 20 (FIG. 2B), and conductor 33 enable switched power feeds to a series of diffuser diodes 41, 43, and 45 in the rear of belt 10 (FIG. 1B) or 20 (FIG. 2B). Switching of power over conductors 31 and 33 is accomplished by timing circuits of controller 30. Conductors utilized in belt 10 or 20, insulated or non-insulated, may comprise conventional metal (e.g., coated or uncoated copper) wires, or alternatively, intrinsically conductive polymers such as commercially available conductive nylons or polyester urethanes, or other flexible conductive materials capable of withstanding without breakage when subjected to repeated bending and tensile forces due to movement of the wearer. Moisture and water exposure of the belt may also dictate requirements of the conductors to provide reliable operation of the diode circuits. Some or all of the electrical components may be encapsulated with plastic, polymers, or rubber to attained water or moisture proofing and yet still maintain flexibility to withstand repeated bending and stretching. The entire circuit comprising the controller, battery, wiring harness and LEDs also may be encapsulated for complete waterproofing, or even water-submersible.

Mode switch 36, depressed by the user, is provided to cycle between control of on-off status (steady state on) and/or various blinking patterns of the diffuser strip. Blinking patterns, established by conventional timing circuits of controller 30, may include one second on-off blinking, rapid blinking multiple times (e.g., five to ten) per second, or other sequence of blinking, such as, for example, a blinking SOS Morse Code signal. The controller may apply blinking control to either or both the path-lighting diodes and the diffuser strip diodes. Controller 30 may include an on-off switch 34 to disconnect battery 32 from the path-lighting diodes. In the case where the belt 10 or 20 includes separate banks or groups of LEDs for multiple colors (e.g., red, yellow, orange), the controller 30 may include a wiring harness and/or mode switch for each such LED bank or group for separate and individual control on-off or blinking patterns of the respective groups of LEDs.

The foregoing description and accompanying drawings are intended to illustrate but not limit the invention, which is defined by the appended claims. Based on the teachings herein, the invention includes various modifications and adaptations as may come to those skilled in the art.

1. A lighted safety belt to provide path lighting for the wearer and to signal presence of the wearer on approaching traffic, said safety belt comprising:
a band of flexible material having a front segment and a rear segment,
a series of path lighting diodes in the front segment to provide path lighting in a direction of movement of the wearer,
a light diffusing strip coextensive with a portion of the rear segment of said band to scatter light emitted from a series of light-emitting diodes associated therewith,
a battery,
a wiring harness to provide electrical power to said path-lighting diodes and diffusing strip, and
a controller to control on-off switching of power to said path-lighting diodes and to said diffusing strip.

2. A wearable safety belt that provides presence-signaling and path lighting in darkness, said safety belt comprising:
an elongated band of material to encircle a least a portion of a waist of a wearer,
path-lighting diodes in a front segment of said band to provide path lighting in a direction of movement of the wearer, [said diodes having lenses to focus light forwardly],
a diffuser strip coextensive with at least a rearward-facing portion of said band, said diffuser strip having a plurality of LEDs and a light-diffusing material to illuminate said diffuser strip,
a source of battery power,
a wiring harness extending along said band of material to provide electrical power from said battery to said diodes and to said diffuser strip, and
a controller embodied in a housing of said belt to control on-off switching of power to said diodes and said diffuser strip whereby to illuminate a path of movement of said wearer and to signal the presence/whereabouts of said wearer to approaching vehicles.

3. A lighted safety belt to provide path lighting for the wearer and to signal presence of the wearer on approaching traffic, said safety belt comprising:
a waist band and a should strap,
a series of path lighting diodes disposed in a front segment of the shoulder strap to provide path lighting in a direction of movement of the wearer,
a light diffusing strip coextensive with a portion of the rear segment of said shoulder strap to scatter light emitted from a series of light-emitting diodes associated therewith,
a battery,
a wiring harness to provide electrical power to said path-lighting diodes and to said diffusing strip, and
a controller to control on-off switching of power to said path-lighting diodes and to said diffusing strip.

4. The lighted safety belt of claim 1, wherein said controller provides pre-defined blinking patterns for the diffusing strip LEDs.

5. The lighted safety belt of claim 1, wherein said path lighting diodes include lenses to focus emitted light in a forward direction of movement of said wearer.

6. The lighted safety belt of claim 1, wherein said wiring harness comprises intrinsically conductive flexible polymers as conductors.

7. The lighted safety belt of claim 1, wherein said controller is encapsulated with a moisture-impermeable layer of material to provide moisture-proofing or water-proofing.

8. The lighted safety belt of claim 1, wherein said controller provides selectable blinking patterns for both said path lighting diodes and said light diffusing strip.

9. The lighted safety belt of claim 1, wherein said belt comprises nylon.

10. The lighted safety belt of claim 1, wherein said diffusing strip comprises respective banks of different color diodes and said controller controls on-off switching or blinking patterns for each respective group of different color diodes.

11. The lighted safety belt of claim 1, further including a compartment in said band and said controller and battery are located within said compartment.

12. The lighted safety belt of claim 3, wherein said controller provides pre-defined blinking patterns for the diffusing strip LEDs.

13. The lighted safety belt of claim 3, wherein said path lighting diodes include lenses to focus emitted light in a forward direction of movement of said wearer.

14. The lighted safety belt of claim 3, wherein said wiring harness comprises intrinsically conductive flexible polymers as conductors.

15. The lighted safety belt of claim 3, wherein said controller is encapsulated with a moisture-impermeable layer of material to provide moisture-proofing or water-proofing.

16. The lighted safety belt of claim 3, wherein said controller provides selectable blinking patterns for both said path lighting diodes and said light diffusing strip.

17. The lighted safety belt of claim 3, wherein said belt comprises nylon.

18. The lighted safety belt of claim 3, wherein said diffusing strip comprises respective banks of different color diodes and said controller controls on-off switching or blinking patterns for each respective group of different color diodes.

19. The lighted safety belt of claim 3 further including a compartment located within said belt, and said controller and battery are located within said compartment.

20. The lighted safety belt of claim 19, wherein said compartment is located within said waist band.
